(19) United States
(12) Patent Application Publication
(10) Pub. No.: US 2011/0036410 A1
(43) Pub. Date: Feb. 17, 2011

(54) Recycling of grey water

(76) Inventor: Lorne Tontegode, Ajax (CA)

Correspondence Address: Muncy, Geissler, Olds & Lowe, PLLC, 4000 Legato Road, Suite 310, FAIRFAX, VA, 22033, US

(21) Appl. No.: 12/805,707

(22) Filed: Aug. 16, 2010

(30) Foreign Application Priority Data
Aug. 14, 2009 (CA) 2,675,539

(51) Int. Cl. F17D 1/00

(52) U.S. Cl. 137/1; 137/255

(57) ABSTRACT

A charging conduit extends from a source of grey water to a separate inlet of two tanks arranged in parallel. A discharging conduit extends from a separate outlet of each tank to the source of grey water for recycling the grey water. Upper and lower level-detectors are provided for each tank and a flow detector monitors the flow of grey water through the discharging conduit. Valves control the flow of grey water into and out of each tank and respond to the level of grey water in the tanks monitored by the level-detectors.

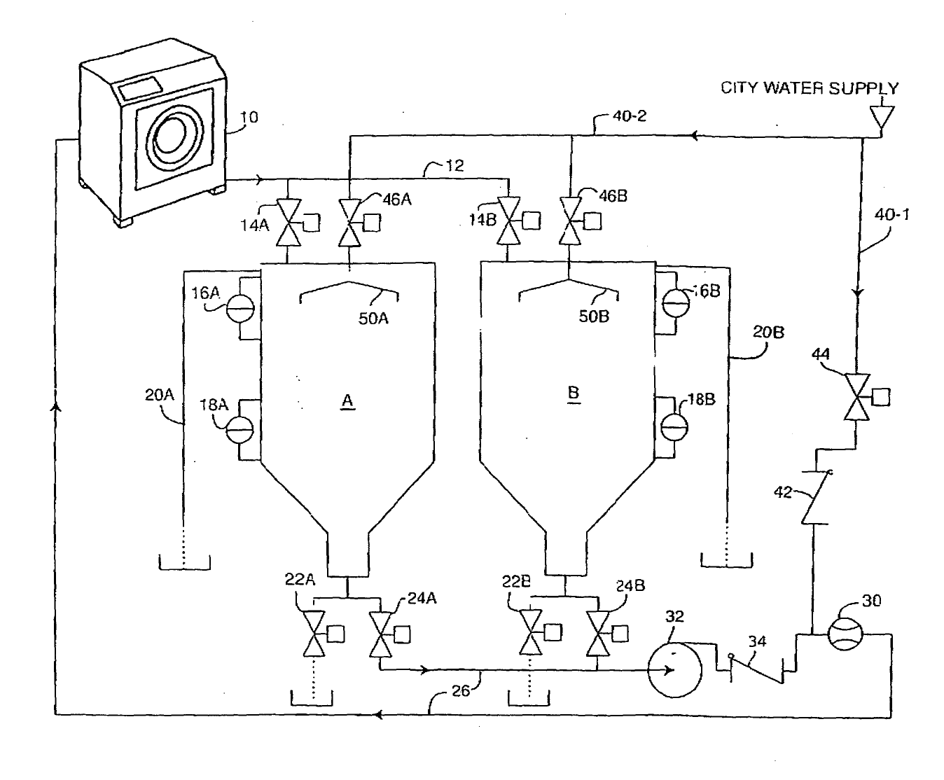

### FIELD OF THE INVENTION

This invention relates to the recycling of waste or grey water and more particularly to the recycling of waste or grey water in a way which minimizes the build-up of bacteria and precipitates in the water.

### BACKGROUND OF THE INVENTION

In my application for a patent filed in the Canadian Intellectual Property Office on May 2, 2008 as U.S. Pat. No. 2,630,332 I describe a method and apparatus for recycling water after use in commercial processes such as laundries in hospitals, hotels or in laundromats. The method and apparatus are also useful in industrial processes such as in bottling plants where bottles must be sterilized in hot water. The waste or grey water, referred to below as grey water, while not potable, is reasonably clean after use and is suitable for reuse in many processes where non-potable water is permissible. Significant savings are achieved by recycling and reusing such grey water over using fresh water in such processes.

In many commercial and industrial processes, water is consumed periodically but not continuously. For example, a washing machine, even if it is operating continuously, requires water during its washing and rinsing cycles hut not between the cycles and not during the drying cycle. In a hospital or hotel, washing machines are usually not operating continuously but only during part of the day so that not only do they not require water when, they are not operating but also, periodically, when they are. While the machines are operating, grey water must be stored and available for immediate use.

While the machines are not in use, grey water must be stored for later use. While the grey water is being stored, bacteria may form in it. As well, soluble impurities and impurities in suspension may settle on die interior surfaces of the containers in which the grey water is stored and clog the flow of grey water through the containers.

In a conventional installation, grey water is stored in a single tank. Incoming water is mixed with the water that is presently in the tank and bacterial growth is minimized by the addition of chemicals into the tank, The constant addition and extraction of grey water from the tank does not completely remove old grey water that has been in the tank for a prolonged period of time and that water, even if only a trace, is a source of bacteria. The only way to ensure that this old grey water is not present in the tank is to completely drain the tank. Alternatively the contents of the tank can be chemically shocked in order to kill the bacteria in the old water.

The less time that grey water is stored, the less growth of bacteria and the less precipitation of impurities occur. To minimize the storage time, the first quantity of grey water stored should be the first quantity of grey water recycled and reused. In other words, storage and reuse should occur on a so-called “FIFO” sequence in which grey water which first flows into storage should he the first water to be withdrawn from storage and recycled. Preferably, in addition to that, the tank in which the grey water should he periodically drained to remove all traces of old water.

### SUMMARY OF THE INVENTION

I have invented a process and an apparatus in which grey water is recycled and reused on a FIFO sequence. Briefly the apparatus of my invention includes two tanks, one referred to below as “tank A” and the other as “tank B”. A charging conduit extends from a source of grey water to a separate inlet of each tank and a discharging conduit extends from a separate outlet of each tank to a source of grey water. Valves at the inlets of the two tanks control the flow of grey water from the charging conduit into the tanks. The inlet valve of tank A is normally open while the other inlet valve is normally closed. Upper and lower level-detecting means detect preselected maximum and minimum levels of grey water within each tank and valves at the outlet of the two tanks control the flow of grey water into the discharging conduit from the tanks.

There is means responsive to detection by the upper level-detecting means in tank A that the level of grey water within the tank has reached the maximum level for causing the inlet valve of that tank to close and the inlet valve of tank B to open with resulting termination of the flow of grey water from the charging conduit into tank A an initiation of the flow of grey water into tank B. There is also means, responsive to detection by the upper level-detecting means of tank B, that the level of grey water within that tank has reached the maximum level for causing the latter valve to close and for causing the inlet valve of tank A to open, with resulting termination of the flow of grey water from the charging conduit into tank B and resumption of the flow of grey water into tank A.

There is a flow-detecting means for detecting the flow of grey water through the discharging conduit and for opening the outlet valve of tank A with resulting initiation of the flow of grey water from tank A into the discharging conduit. A first overriding means is responsive to detection by the lower level-detecting means in tank A that the level of grey water within tank A is below the minimum level for overriding the outlet valve of that tank with resulting closing of the latter valve and opening of the outlet valve of tank B. A second overriding means is responsive to detection by the lower level-detecting means that the level of grey water within tank B is below the minimum level for overriding the outlet valve of that tank with resulting closing of the latter valve and opening of the outlet valve of tank A.

### DESCRIPTION OF THE DRAWING

The drawing is a schematic representation of the components of the apparatus of the invention.

### DESCRIPTION OF PREFERRED EMBODIMENT

With reference to the drawing, a conventional washing machine is identified by the numeral 10 and constitutes the source of grey water for purposes of the description which follows. As previously indicated however, the grey water may originate from other sources such as laundries in hospitals and hotels and bottling plants. Rain water may also be the source of the grey water.

The grey water from the washing machine can comprise both usable and unusable grey water in the subject process. Grey water is water that is mildly contaminated by non-toxic pollutants such as small quantities of sand and mud and household waste such as left-over food and vegetable cuttings. Water produced during the rinsing cycle of a washing machine is generally usable for recycling in the subject process but water produced during the washing cycle may not be, particularly where clothes being washed are heavily soiled or contaminated by oil or lubricants. Unusable grey water is discarded by being flushed down a drain.

Rinse water and relatively clean water produced during the washing cycle, referred to below as grey water, flows into a charging conduit 12 which extends from the washing machine to two tanks, a first tank A and a second tank B. Valves 14A, 14B at the inlets of the two tanks control the flow of grey water into the tanks. Valve 14A is normally open while valve 14B is normally closed.

Upper and lower level switches 16A, 18A are provided in tank A. The upper level switch is activated when the level of grey water in the tank exceeds a preselected maximum value while the lower switch is activated when the level of grey water drops below a preselected minimum value. Similarly, upper and lower level switches 16B, 18B are provided in tank B.

Grey water above the maximum level in the two tanks discharges to a drain through conduits 20A,B while grey water below the minimum level, when the lower level switches detect that the level of grey water is below the minimum level, discharge to a drain through purge valves 22A,B at the bottom of the two tanks.

Valves 24A, B at the outlets of the two tanks control the flow of grey water into a discharging or return conduit 26. The latter conduit forms a return portion of a loop or circuit which extends from the tanks to the washing machine. Charging conduit 12 forms the forward portion of the loop.

A flow switch 30 is provided in the loop for detecting the movement of grey water in Ute return portion of the loop. When it detects movement, it causes a pump 32 to activate to cause the grey water to flow to the washing machine. A check valve 34 ensures that the flow is from the tanks to the washing machine and not in the opposite direction.

Pressure is maintained within the loop by means of pressurized water from a municipal source. Water from the municipal source flows through branch 40-1 of a conduit to the loop. A check valve 42 in the latter conduit prevents the grey water in the loop from flowing into conduit 40-1 and a normally open fresh water valve 44 in conduit 40-1 closes when flow switch 30 detects movement of grey water in the loop. Water from the municipal source also flows through branch 40-2 to the two tanks A,B and spray valves 46A,B control the flow of water from branch 40-2 into the tanks.

While the apparatus is on standby and the recycling process of the invention is inactive, pressure of grey water within the return portion 26 of the loop is maintained at the required value by the pressure of municipal water in conduit 40-1.

The recycling process of the invention begins when rinse water from the washing machine discharges into charging conduit 12 and flows to inlet valves 14A,B. Valve 14A being normally open allows the rinse water to flow into tank A while inlet valve 14B being normally closed prevents the rinse water from entering the other tank B. When the level of rinse water in tank A reaches upper level switch 16A, inlet valve 14A closes and inlet valve 14B opens to divert rinse water into tank B.

When there is a demand for recycled rinse water by the washing machine by, for example, the opening of a valve in the machine to admit the recycled water, the water begins to flow through return or discharging conduit 26. Flow switch 30 detects the flow and activates pump 32. The flow switch also causes the normally open fresh water valve 44 to close thereby preventing municipal water from flowing into the conduit. At all times, check valves 34, 42 prevent rinse water from flowing in the wrong direction. The latter check valve also prevents municipal water from flowing backward through the pump and filling the two tanks A,B.

When the rinse water in tank A falls to the level detected by the lower level switch 18A, the switch causes outlet valve 24A to close and outlet 24B to open. The switch also causes purge valve 22A at the bottom of the tank and spray valve 46A at the top to both open. Municipal water then discharges through a spray nozzle 50A into the interior walls of the tank to clean its walls. The cleaning water discharges through purge valve 22A. As well, rinse water which collects beneath the lower level switch 18A discharges at this time. Such rinse water is usually unsuitable for recycling since it may contain solid particles which settle into the lower portion of the tank. After a preselected time, purge valve 22A and spray valve 46A close.

Between washing and rinsing cycles of the washing machine, when recycled rinse water is not required, flow switch 30 shuts off pump 32 and opens fresh water valve 44. After a predetermined interval of time, if rinse water is not withdrawn from one tank, the purge valve at the bottom of the tank opens and all rinse water in the tank is purged in order to prevent stagnant rinse water from being recycled to the washing machine.

As the operation of the washing machine progresses through its washing and rinsing cycles, rinse water is periodically discharged and subsequently consumed by the washing machine. As previously mentioned, the discharged rinse water flows first to tank A and then to tank B. As the rinse water in the tanks is required by the washing machine, rinse water from tank A is withdrawn first and, when the level of rinse water in that tank reaches the lower level switch, rinse water from tank B is then withdrawn until the level of rinse water in that tank reaches the lower level switch.

The sequence of withdrawal of rinse water from the tanks is first from tank A and then from tank B. The subject process is accordingly a so-called “FIFO” sequence in which rinse water which first flows into one or the other of the tanks is the first rinse water to be withdrawn from that tank and recycled. A FIFO sequence is desirable because the less time that rinse water remains in a tank, the less time there is for bacteria to grow and precipitates to form in the water.

The problem caused by old grey water that has been in the tank for a prolonged period of time in a conventional grey water system is accordingly not a problem in the subject process. Such old water, as previously discussed, is a source of bacteria but such water is either the first water withdrawn in the subject FIFO process or it is drained out of a tank each time that grey water has been withdrawn from the tank and before in-coming grey water is added to it.

It will be understood, of course, that modifications can be made in the process and apparatus of the invention without departing from the scope and purview of the invention as described above and in the appended claims.

I claim:

1. Apparatus for recycling grey water including: a pair of tanks A and B; a grey water charging conduit which extends from a source of grey water to a separate inlet of each said tank; a grey water discharging conduit which extends from a separate outlet of each said tank to said source of grey water for recycling said grey water; a valve at each said inlet for controlling the flow of grey water from said charging conduit into said tank A and tank B; upper and lower level-detecting means for detecting preselected maximum and minimum levels of grey water within each said tank; a valve at each said outlet for controlling the flow of grey water from said tanks into said discharging conduit; means responsive to detection by said upper level-detecting means that the level of grey water in said tanks A and B has reached said maximum level; flow detecting means for detecting the flow of grey water through said discharging conduit; overriding means responsive to detection by said lower level-detecting means of said tank A and tank B that the level of grey water therein is below said minimum level.

2. The apparatus of claim 1 further including means for maintaining the pressure of said discharging conduit at a predetermined value.

3. The apparatus of claim 2 further including a pump activated at the time said flow detecting means detects the flow of grey water in said discharging conduit for adjusting the rate of flow through said discharging conduit to a predetermined rate and means for disabling said pressure maintaining means upon activation of said pump,

4. The apparatus of claim 1 further including a pair of purge valves each being normally closed and each serving to purge any grey water within a separate said tank, each said purge valve being responsive to detection by said lower level-detecting means that the level of grey water within said separate said tank is below said minimum level and causing said purge valve to open to allow any grey water within said separate tank to exit to a drain.

5. A process for recycling of grey water including the steps of providing a pair of tanks A and B; providing a grey water charging conduit which extends from a source of grey water to a separate inlet of each said tank; providing a grey water discharging conduit which extends from a separate outlet of each said tank to said source of grey water; providing a valve at each said inlet for controlling the flow of grey water from said charging conduit into said tanks A and B, causing said inlet valve of said tank A to be normally open and said inlet valve of said tank B to be normally closed; providing upper and lower level-detecting means for detecting preselected maximum and minimum levels of grey water within each said tank; providing a valve at each said outlet for controlling the flow of grey water from said tanks into said discharging conduit; providing means responsive to detection by said upper level-detecting means of said tank A that the level of grey water therein has reached said maximum level for causing said inlet valve of said tank A to close and said inlet valve of said tank B to open with resulting termination of the flow of grey water into said tank A and initiation of the flow of grey water into said tank B; providing means responsive to detection by said upper level-detecting means of said tank B that the level of grey water therein has reached said maximum level for causing said inlet valve of said tank B to close and for causing said inlet valve of said tank A to open, with resulting termination of the flow of grey water into said tank B and resumption of the flow of grey water into said tank A; providing flow detecting means for detecting the flow of grey water through said discharging conduit and for opening said outlet valve of said tank A with resulting initiation of the flow of grey water from said tank A into said discharging conduit; providing first overriding means responsive to detection by said lower level-detecting means of said tank A that the level of grey water therein is below said minimum level for overriding said outlet valve of said tank A with resulting closing of the latter said valve and opening of said outlet valve of said tank B; and providing second overriding means responsive to detection by said lower level-detecting means of said tank B that the level of grey water therein is below said minimum level for overriding said outlet valve of said tank B with resulting closing of the latter said valve and opening of said outlet valve of said tank A.

6. The process of claim 5 further including providing means for maintaining the pressure of said discharging conduit at a predetermined value.

7. The process of claim 6 further including providing a pump which activates at the time said flow detecting means detects the flow of grey water in said discharging conduit for adjusting the rate of flow through said discharging conduit to a predetermined rate and means for disabling said pressure maintaining means upon activation of said pump.

8. The process of claim 5 further including providing a pair of purge valves each being normally closed and each serving to purge any grey water within a separate said tank, each said purge valve being responsive to detection by said lower level-detecting means that the level of grey water within said separate said tank is below said minimum level and causing said purge valve to open to allow any grey water within said separate tank to exit to a drain.
